(19) United States
(12) Patent Application Publication
(10) Pub. No.: US 2019/0258977 A1
(43) Pub. Date: Aug. 22, 2019

(54) METHOD SYSTEM AND APPARATUS FOR COORDINATING PRODUCTION OF GOODS

(71) Applicant: Nulogy Corporation, Toronto (CA)

(72) Inventors: Jason Yuen, Toronto (CA); Kevin Wong, Toronto (CA); Kevin Chen, Montreal (CA); Scott Johnson, Toronto (CA); Lily Zhang, Toronto (CA); Allan Maltais, Toronto (CA); Arturo Pie, Toronto (CA); Evan Brodie, Toronto (CA); Ned Schwartz, Toronto (CA); Nick Norbeck, Toronto (CA); Jason Kurian, Toronto (CA); Jon Erik Suero, Toronto (CA); Alistair McKinnell, Toronto (CA); Jerridan Quiring, Toronto (CA); David Tangness, Toronto (CA)

(21) Appl. No.: 16/347,833

(22) PCT Filed: Nov. 7, 2017
(86) PCT No.: PCT/IB2017/056958

§ 371 Date: May 7, 2019

Related U.S. Application Data
(60) Provisional application No. 62/418,558, filed on Nov. 7, 2016.

(51) Int. Cl. G06Q 10/06; G06Q 10/08; H04L 12/18; H04L 12/58; H04L 29/08

(52) U.S. Cl. CPC G06Q 10/06314; G06Q 10/087; H04L 67/1095; H04L 51/18; H04L 12/18

(57) ABSTRACT

An intermediate server synchronizes reporting data between a requestor computing device and an effector computing device. The server stores a plurality of event identifiers, and a plurality of reporting templates. Each template has a template identifier, and a mapping between a subset of the event identifiers and a set of reporting stages. The server, responsive to a production task request from the requestor device, obtains a selected templated identifier and generates a reporting data record for the production task request. The reporting data record includes fields for each stage defined by the selected template. After relaying the production task request to the effector device, the server receives reporting data from the effector device, containing values corresponding for a reported subset of the events. The server stores a portion of the values in the reporting data record according to the template; and transmits the reporting data record to the requestor device.

### FIELD

The specification relates generally to contract manufacturing and packaging, and specifically to a method, system and apparatus for coordinating the production of goods.

### BACKGROUND

Contract manufacturing and packaging often involve high variability in the nature of goods being produced, as well as short production runs. Further, in contract scenarios different entities manage different subsets of the various interdependent activities in such production runs, which must therefore be tightly coordinated. This presents challenges both for suppliers and customers (the receivers of the goods produced, who generally then supply those goods into retail environments or directly to consumers). For example, frequent and time-consuming exchanges of information, generally achieved via email or telephone, are often necessary to initiate the production of a set of goods. It may also be desirable for the customers to obtain status information during the production run. Such information is generally obtained from the suppliers on an ad-hoc basis, requiring that suppliers devote personnel to collecting and reporting the necessary information.

### SUMMARY

According to an aspect of the specification, a method is provided, in an intermediate server, of synchronizing reporting data between a requestor computing device and an effector computing device, comprising: storing a plurality of event identifiers at the intermediate server; storing a plurality of reporting templates at the intermediate server, each reporting template having: (i) a template identifier, and (ii) a mapping between a subset of the plurality of event identifiers and a set of reporting stages; responsive to receiving a production task request from the requestor computing device, obtaining a selected templated identifier of a selected one of the templates; generating a reporting data record corresponding to the production task request, the reporting data record including respective fields for the stages defined by the selected reporting template; responsive to relaying the production task request to the effector computing device, receiving reporting data from the effector computing device, the reporting data containing values corresponding to each of a reported subset of the events; storing a portion of the values in the reporting data record according to the mapping defined by the selected reporting template; and transmitting the reporting data record to the requestor computing device.

### BRIEF DESCRIPTIONS OF THE DRAWINGS

Embodiments are described with reference to the following figures, in which:

FIG. 1 depicts a system for coordinating the production of goods, according to a non-limiting embodiment;

FIG. 2 depicts certain internal components of the server of FIG. 1, according to a non-limiting embodiment;

FIG. 3 depicts a method of coordinating the production of goods, according to a non-limiting embodiment;

FIG. 4 depicts an interface presented by the server of FIG. 1 to the customer computing device of FIG. 1, according to a non-limiting embodiment;

FIG. 5 depicts an interface generated by the server of FIG. 1 during the performance of block 310 of the method of FIG. 3, according to a non-limiting embodiment;

FIG. 6 depicts an interface generated by the server of FIG. 1 during the performance of block 330 of the method of FIG. 3, according to a non-limiting embodiment; and

FIGS. 7-10 depicts additional interfaces generated by the server of FIG. 1 during the performance of the method of FIG. 3.

### DETAILED DESCRIPTION OF THE EMBODIMENTS

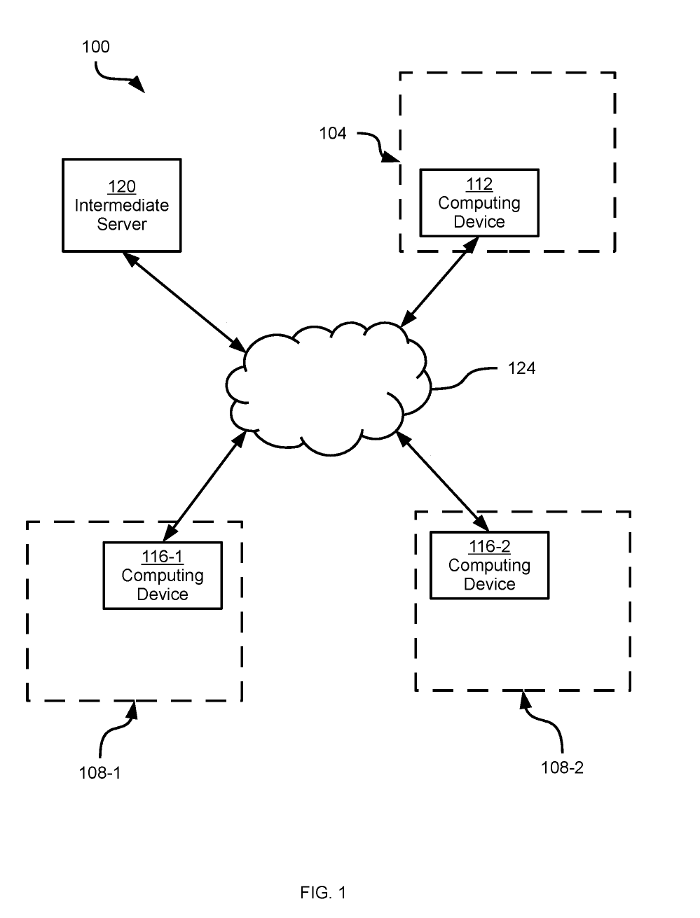

FIG. 1 depicts a system 100 for coordinating the production of goods. The nature of the goods produced in system 100 is not particularly limited; indeed, the nature of such goods is typically highly variable over time. Examples of such goods include those referred to as fast moving consumer goods (FMCG) and consumer packaged goods (CPG), such as healthcare products, cosmetics, over-the-counter pharmaceuticals, and the like. Various other types of goods are also contemplated, however, including any of, or any combination of, clothing, foodstuff, and the like. Two categories of entities generally participate in the operation of system 100—customers (also referred to as brand entities or brands, or simply as requestors), and suppliers (also referred to as contract packagers or contract manufacturers, or simply as effectors). Suppliers produce goods or materials, or package previously produced goods, for delivery to the customers. Some suppliers may act as suppliers to other suppliers. The customer entities, in turn, deliver the goods either directly to end consumers, or to retail entities (not shown) for sale to end customers.

System 100 therefore includes a brand facility 104 (other brand facilities may also be included, but one is illustrated for simplicity), as well as a supplier facility 108 (two facilities 108-1 and 108-2 are shown for illustrative purposes, which are generally referred to as a facility 108). Each of the above-mentioned facilities includes any necessary equipment, buildings (at a single site or distributed across more than one site) and the like to support the operations of the respective entity. For example, each supplier facility 108 generally includes at least a receiving area for receiving and storing raw material (e.g. packaging materials, ingredients or components of the good produced by the supplier, and the like), a production line for converting the raw material into goods (e.g. as requested by the brand entity), and a shipping area for collecting the goods produced and shipping the goods out to their destinations (e.g. brand facility 104).

Each facility 104, 108 also includes a computing device. In particular, brand facility 104 includes a computing device 112, supplier facility 108-1 includes a computing device 116-1 and supplier facility 108-2 includes a computing device 108-2. Each computing device executes one or more software applications for coordinating the operations of its respective facility. Various conventional materials and production management applications are available for execution by computing devices 112 and 116.

Traditionally, the initiation of a production run at either supplier facility 108 requires the exchange of information between personnel at brand facility 104 and the relevant supplier facility 108, for example by email or telephone. The information (e.g. the item to be produced, the price, the quantity to be produced and the like) is then provided manually to computing devices 112 and 116 via data entry devices such as keyboards and mice. Subsequent interactions between facilities (e.g. reporting of production status from the supplier facility 108 to the brand facility 104) are typically performed in a similar manner, with data being obtained from the relevant computing device 116 by an operator and transmitted to personnel at facility 104 via email, telephone or the like.

System 100, in contrast, also includes an intermediate server 120 connected to each of computing devices 112, 116-1 and 116-2 via a network 124. Network 124 can be any suitable combination of wide area networks, such as the Internet, mobile wireless networks and the like. As will be discussed in greater detail below, intermediate server 120 is configured to communicate with computing devices 112 and 116 to permit those computing devices to exchange data for initiating production runs, and to exchange reporting data concerning the production runs.

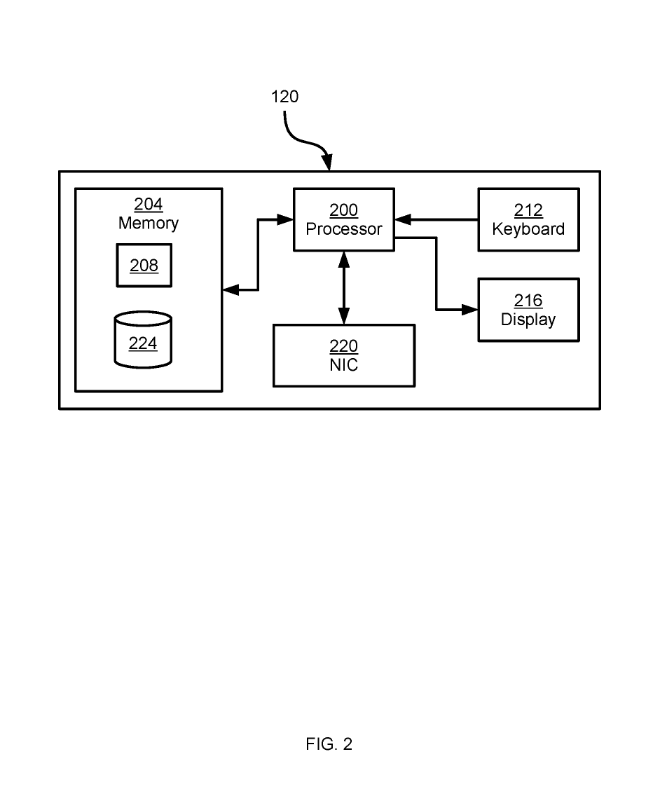

Turning now to FIG. 2, certain internal components of server 120 are shown. Server 120 includes a processor 200 interconnected with a non-transitory computer readable storage medium such as a memory 204. Memory 204 can be any suitable combination of volatile (e.g. Random Access Memory (“RAM”)) and non-volatile (e.g. read only memory (“ROM”), Electrically Erasable Programmable Read Only Memory (“EEPROM”), flash memory, magnetic computer storage device, or optical disc) memory. Memory 204 also maintains computer-readable instructions executable by processor 200. Such instructions include, for example, an operating system and one or more applications. One such application shown in FIG. 2 is an intermediation application 208 (referred to as “application 208” herein). Processor 200, via execution of the instructions contained within application 208, is configured to carry out various actions, as will be discussed below. It is contemplated that application 208 can be maintained on other non-transitory computer readable media than memory 204, such as optical media, flash media and the like.

Server 120 can also include input and output devices interconnected with processor 200, such as a keyboard 212 and a display 216, respectively. It is contemplated that other input and output devices can also be used with server 120, including, for example, touch screens, speakers, microphones and the like. In some examples (not shown), keyboard 212 and display 216 can be omitted and server 120 can instead be administered from an additional terminal, such as a personal computer with associated input and output devices, connected with server 120. Such a terminal can be located, for example, within the same facility as server 120. In other examples, such a terminal can be located remotely from server 120 and can interact with server 120 over network 124. Terminals can include desktop computers as well as various mobile computing devices, such as laptop computers, mobile phones, tablet computers and the like.

Server 120 also includes a network interface controller (NIC) 220, also referred to herein as a communications interface, for connecting server 120 to network 124. NIC 220 therefore includes any suitable hardware (e.g. Ethernet controllers, radios, and the like) for interconnecting with network 124.

Server 120 also stores, in memory 204, a repository 224 containing various types of data employed by server 120 during the execution of application 208, as will be described in further detail below.

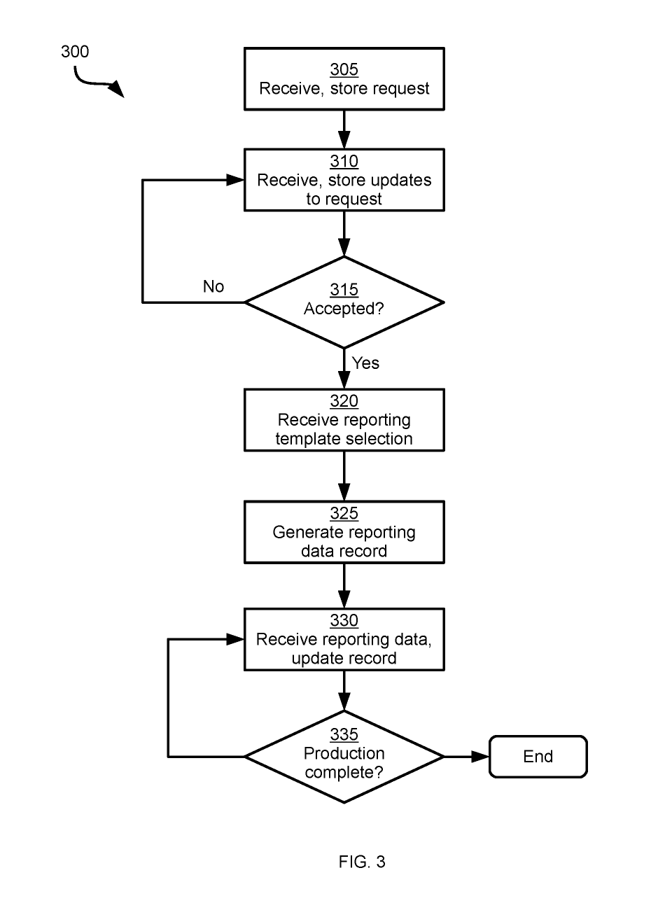

Turning to FIG. 3, the functionality of system 100 generally, and server 120 in particular, will be illustrated via the performance of a method 300 of coordinating the production of goods. The blocks of method 300 are performed by server 120; more specifically, the blocks of method 300 are performed at server 120 via the execution of application 208 by processor 200.

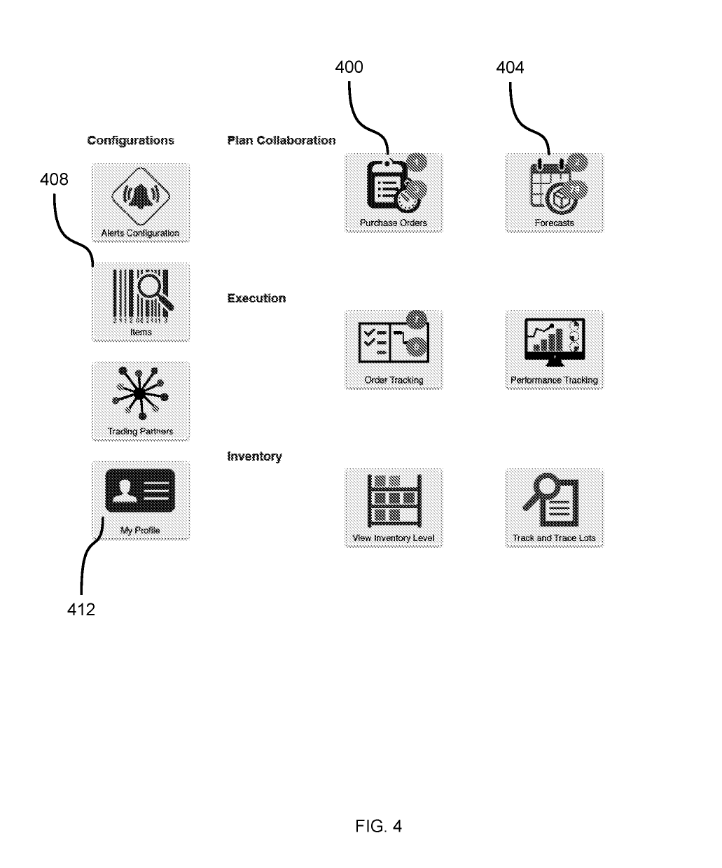

At block 305, server 120 is configured to receive a production request from computing device 112. In the present example, computing device 112 generates the request by first requesting from server 120 a web page such as that illustrated in FIG. 4. The web page includes a plurality of selectable elements, including a purchase order element 400 and a forecast element 404. An operator of computing device 112, via the selection of element 400, initiates the creation of a purchase order request (i.e. a request for the production of goods). The web page shown in FIG. 4 may be updated by server 120 to display, at computing device 112, a web page defining a purchase order creation interface. Server 120 receives, via the purchase order creation interface, data defining a production request. The data includes an item identifier, which need not be meaningful to server 120, although server 120 can store an item database in some embodiments, accessible via a selectable element 408 shown in FIG. 4. The item database can contain data defining any suitable number of items, and can include parameters such as per-unit price, subcomponents, item identifiers, and the like. The data received at block 305 can also include a purchase order identifier, purchase order line item identifier, and the like.

In other embodiments, the request received at block 305 can be generated by computing device 112 via the execution of the production management application executed by computing device 112 and sent to server 120 and computing device 116. For example, an operator may interact with computing device 112 (without communication with server 120) to create an order record. Computing device 112 can then be configured to format the order record for transmission, for example as an electronic data interchange (EDI) document, and transmit the formatted order record to server 120. Server 120 can be configured to relay the formatted order record to the appropriate computing device 116, or computing device 112 can transmit the record directly to the appropriate computing device 116 substantially simultaneously with the transmission to server 120.

The production request data also includes a requested quantity of the item in question, a payment price (to the supplier that will produce the item—this may be omitted, however), and a due date for the production run (e.g. the date by which the items are expected to be delivered to facility 104). The production request data also includes a supplier identifier. The supplier identifier can be selected (e.g. via drop-down menu) from a list of supplier identifiers stored in repository 224. Server 120 can store profile data for each supplier and customer entity in repository 224 (accessible via a selectable element 412 shown in FIG. 4). Each profile includes an indication of whether the entity is a customer or a supplier, and also includes an identifier of the corresponding entity. Various other profile data can also be stored, including the physical location of the facility corresponding to the profile, previous performance data for the corresponding entity (e.g. a record of previously requested or completed production runs).

Additional examples of profile data include the production capacity of a facility, the production capabilities of a facility (e.g. the type of equipment present at the facility, which server 120 can compare to stored manufacturing requirements of the requested goods), regulatory certifications (e.g. for food-handling or pharmaceutical manufacturing), and the like.

In some embodiments, every supplier identifier stored in repository 224 may be presented for selection. In other embodiments, only a subset of the available supplier identifiers may be presented for selection. For example, server 120 can automatically limit the list of available suppliers for a given production request based on the item selected for the production request, the historical performance of each supplier, the above-mentioned profile data, and the like.

Having received the production request data at block 305, server 120 is configured to store the request data in a production record in repository 224. The production record includes a customer identifier (identifying the customer that created the request), the above-mentioned supplier identifier, as well as the item identifier, quantity, price and deadline mentioned above. The production record can also include a status value, indicating whether the production run defined by the production record is awaiting a response from the supplier, under negotiation, or accepted. Following the performance of block 305, the initial status indicates that the production record is awaiting a response.

Server 120 is configured, having received the production request and stored the request in repository 224, to notify the supplier identified in the request (e.g. by email, or within a web portal such as that shown in FIG. 4). Following such notification, server 120 is configured to receive updates to the production record at block 310.

Updates to the production record can originate from either or both of computing device 112 and the computing device of the supplier identified in the request (e.g. computing device 116-1). Each supplier computing device 116 can request a listing of any production requests that contain their respective supplier identifiers. Server 120 is configured to present any such requests to the relevant supplier computing device 116, and can also receive updates to the request from the computing device 116.

Updates to the production record can take a variety of forms. For example, computing device 116-1 may submit an update to the production request that indicates conditional acceptance of the production run, if the requested deadline is advanced by three days. In other words, computing device 116-1 can submit proposed changes to various aspects of the production record (although certain items in the production record may be locked, such as the item identifier). The update may also simply consist of an indication of acceptance from computing device 116-1.

Server 120 is configured, in some embodiments, to store and execute rules for assessing whether an update received at block 310 is permissible. For example, memory 204 can store a plurality of update rule records each containing a time-based threshold and an indication of which types of edits are permitted when the corresponding threshold is exceeded. For example, the rule records can specify a plurality of thresholds defined as periods of time before the deadline specified in the production request. An example of such a set of thresholds is eighteen months before the deadline, twelve months before the deadline, four months before the deadline, one month before the deadline, and two weeks before the deadline.

For each threshold, server 120 can store corresponding update criteria that must be satisfied before an update is committed to memory. For example, updates received before the first threshold (e.g. more than eighteen months before the deadline), server 120 can be configured to automatically allow such updates and simply notify the relevant entity that an update has been made. In contrast, updates received within one month of the deadline (that is, exceeding the one-month threshold) may require acceptance from both computing devices 112 and 116 before storage. As a further example, updates received within two weeks of the deadline may simply be refused by server 120.

Server 120 can also be configured to store each update received at block 310, whether or not the update was applied to the production record. In other words, server 120 can store a history of updates to each production record, for example in the form of a plurality of update records containing an identifier of the relevant production record, the content of the update and the like. Each historical record can also include an indication of whether or not the update was applied.

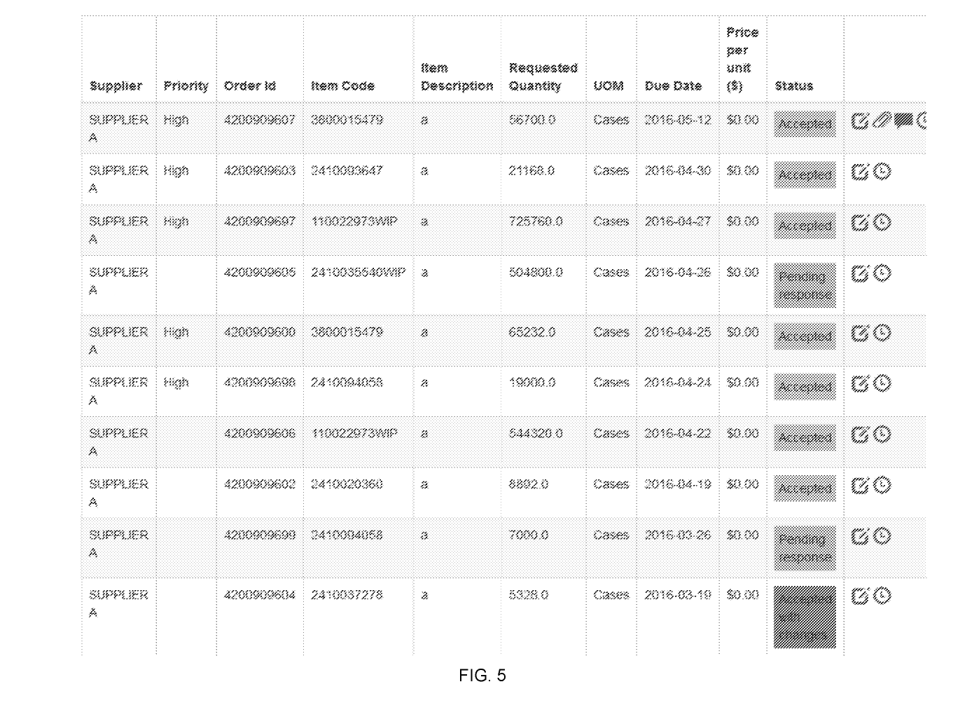

At block 315, server 120 is configured to determine whether the production record has been accepted. When the determination is negative, server 120 awaits further updates (from either computing device 112 or computing device 116-1) and repeats the performance of block 315. Referring to FIG. 5, an example web page (or any other suitable interface for presenting data) presented at computing device 112 following selection of element 400 is illustrated. Each production record stored in memory 204 that corresponds to the customer identifier associated with computing device 112 is shown, along with the current status of each record. Records with the status “pending response” have been submitted by computing device 112, but have not yet been accepted or otherwise acted on by computing devices 116. Records with the status “accepted with changes” have been reviewed by the relevant computing device 116, which has submitted proposed changes to the record. In other words, those records represent a negative determination at block 315, following which server 120 returns to block 310 to await further changes or acceptance from computing device 112. Records with the status “accepted” have been approved with their depicted contents by both computing device 112 and computing device 116-1.

Returning to FIG. 3, following an affirmative determination at block 315, the performance of method 300 proceeds to block 320. As noted earlier, server 120 can act to coordinate the delivery of reporting data concerning a production run from the supplier producing the relevant goods to the customer entity that requested the goods. At block 320, reporting for the production record accepted at block 315 is initiated by receiving a template selection at server 120 from computing device 116-1.

Server 120 is also configured to store a plurality of reporting templates. In general, each reporting template defines at least one stage of production for a given item, and maps at least one reporting event from a computing device 116 to that stage of production. As mentioned earlier, computing devices 116 typically execute applications for managing production activities within facilities 108. Computing devices 116, via the execution of such applications, can be configured to generate reporting data relating to the receipt, production and shipping of goods. The granularity and content of such reporting data varies with the nature of the specific application implemented by each computing device 116.

Server 120 is configured, via the execution of application 208, to process reporting events from computing devices 116 that are formatted according to a common predetermined application programming interface (API). Depending on the capabilities of each computing device 116, the computing device may be able to report smaller or larger subsets of the events defined by the API. For example, the API may define an event for the receipt of a single pallet of a given inventory item, but computing device 116-2 may execute an application that does not gather per-pallet receiving data and is therefore not capable of reporting the above-mentioned event. The API, however, may also define an event indicating that receiving is complete (i.e. all necessary materials for a production run have been received), and computing device 116-2 may gather data indicating that receiving is complete. Therefore, computing device 116-2 is capable of reporting some events defined by the API, and not others.

As will now be apparent, the applications executed by computing devices 116 and computing device 112 may be different, and may therefore not be capable of processing event data reported by another application. The implementation of reporting templates at server 120 permits server 120 to receive production reporting data having a wide variety of levels of granularity and present the reporting data in a consistent manner.

The selection of a template at block 320 can be automatic—for example, server 120 may store a single reporting template for the relevant item (or for the combination of the item and the specific supplier producing the item), and may automatically select that template. Alternatively, server 120 may store a plurality of templates for a given item, and present those templates to computing device 116-1 for selection of a template to use for the current production run.

Table 1 illustrates an example reporting template for a given item. In particular, the template defines four production stages, and maps events to each stage. For example, the stage corresponding to the receipt of packaging material is mapped to two distinct reporting events that computing device 116-1 is capable of reporting. Those events may correspond to two different packaging materials (e.g. boxes and crates). In addition, the template defines targeted completion dates for each stage, relative to the deadline for the production run as a whole.

TABLE 1
Reporting Template

| Stage | Events | Completion |
|---|---|---|
| Receive packaging | receive_A; receive_B | [deadline] - 30 days |
| material | | |
| Receive base material | receive_C | [deadline] - 25 days |
| Production | produce_D | [deadline] - 12 days |
| Shipping | ship_D | [deadline] - 10 days |

Computing devices 116 can also create templates (e.g. if no template exists for the item being produced) for storage at server 120. During template creation, server 120 presents a computing device 116 with a list of available events and available stages (in some embodiments, stages may also be created by computing devices 116). The available events can be configured and stored at server 120, or in other embodiments, can be configured at a separate computing device and identifiers of the events can be provided to server 120. A template is created and stored at server 120 by receiving selections of a set of the available stages, event selections for each stage, and a completion time for each stage.

At block 325, server 120 is configured to generate a reporting data record. The record will be used to store reporting data received from computing device 116-1 during production. In general, the record includes a field for each production stage defined by the template, which will be populated based on the event mapping of the template and the event data received from computing device 116-1.

At block 330, server 120 is configured to receive event reporting data from computing device 116-1. The event reporting data includes an identifier such as a purchase order identifier (e.g. an identifier assigned to the above-mentioned production record), and can also include an identifier of an individual line item in a purchase order, if different goods are identified in the purchase order. In other embodiments, a combination of the supplier, customer and item identifiers can be employed by server 120 to uniquely identify the relevant reporting data record. The event reporting data includes at least one event, which server 120 is configured to compare to the template selected at block 320 in order to populate the reporting data record at block 325. Any events in the event reporting data that are not identified in the template may be discarded, or stored elsewhere in memory 204 (i.e. not in the reporting data record). Events that are identified in the template are employed to update the field of the reporting data record corresponding to the production stages to which those events are mapped. Thus, an event indicating receipt of material A, according to the example template in Table 1, is employed by server 120 to update the packaging material receipt stage of the reporting data record.

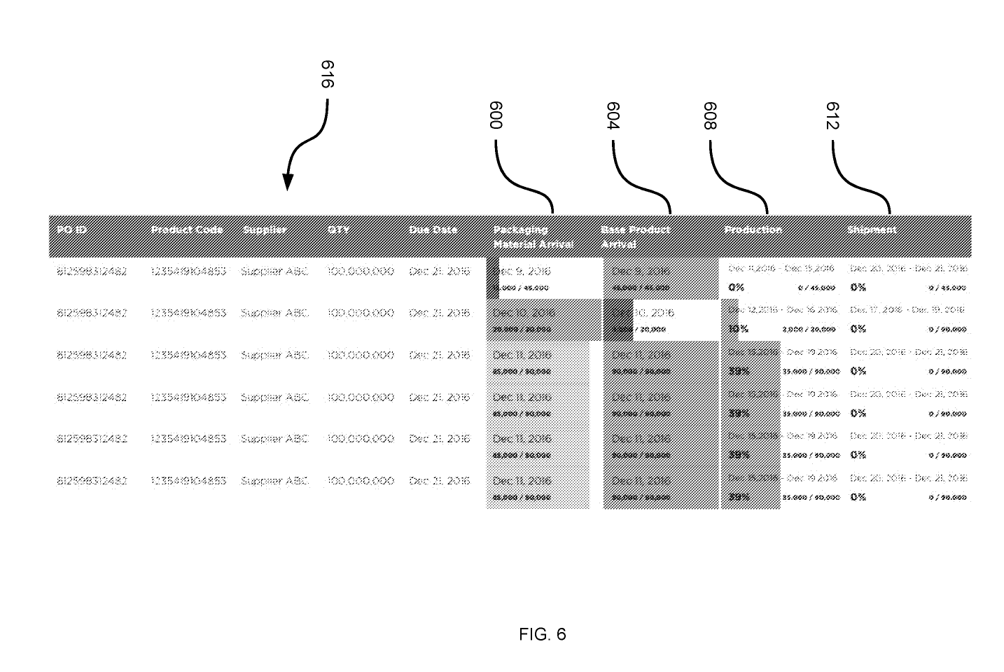

In general, server 120 is configured to update the reporting data record with an indication of the level of completion of each stage identified in the template. The level of completion can be binary (i.e. complete or not complete), or can have greater degrees of granularity, depending on the contents of the event data received from computing devices 116. For example, if computing device 116-1 is configured to generate (and transmit to server 120) event data for each pallet of material that is received at a production line, the reporting data record at server 120 may be updated as shown in FIG. 6. FIG. 6 depicts six reporting data records, each including production data 616 (e.g. the item identifier, quantity and the like; this may also be retrieved from a separate data record in repository 224), as well as fields 600, 604, 608, 612 corresponding to the fields of the templates for each production run. In the present example, it is assumed that the same four stages are identified by each template; in other embodiments, however, different templates can define different sets of stages for each production run. As seen, for example, in column 600 of FIG. 6, the reporting data indicates a fractional level of completion for the receipt of packaging material, based on incremental amounts of material received as indicated in event data from computing device 116-1.

Returning to FIG. 3, at block 335 server 120 is configured to determine whether production is complete. More specifically, server 120 is configured to determine whether the event reporting data received from the computing device 116 indicates that the final stage defined by the template selected at block 320 (the “shipment” stage in Table 1 and FIG. 6) is complete. When the determination at block 335 is affirmative, the performance of method 300 is complete. When the determination at block 335 is negative, server 120 returns to block 330 to await further event reporting data.

During the performance of method 300—and more specifically, at any time after an order is accepted at block 315—computing device 112 can request production tracking data from server 120. In response to the request, server 120 is configured to retrieve the relevant reporting data record, or set of reporting data records, and present the retrieved data to computing device 112 (as shown in FIG. 6, for example).

The request received from computing device 112 can include parameters to define the scope of reporting data records to retrieve. Criteria employed by server 120 to retrieve reporting data records can include a data range for production deadlines, identifiers of one or more suppliers, identifiers of one or more items, and the like. The criteria can be selected at computing device 112 via a web page served by server 120, for example.

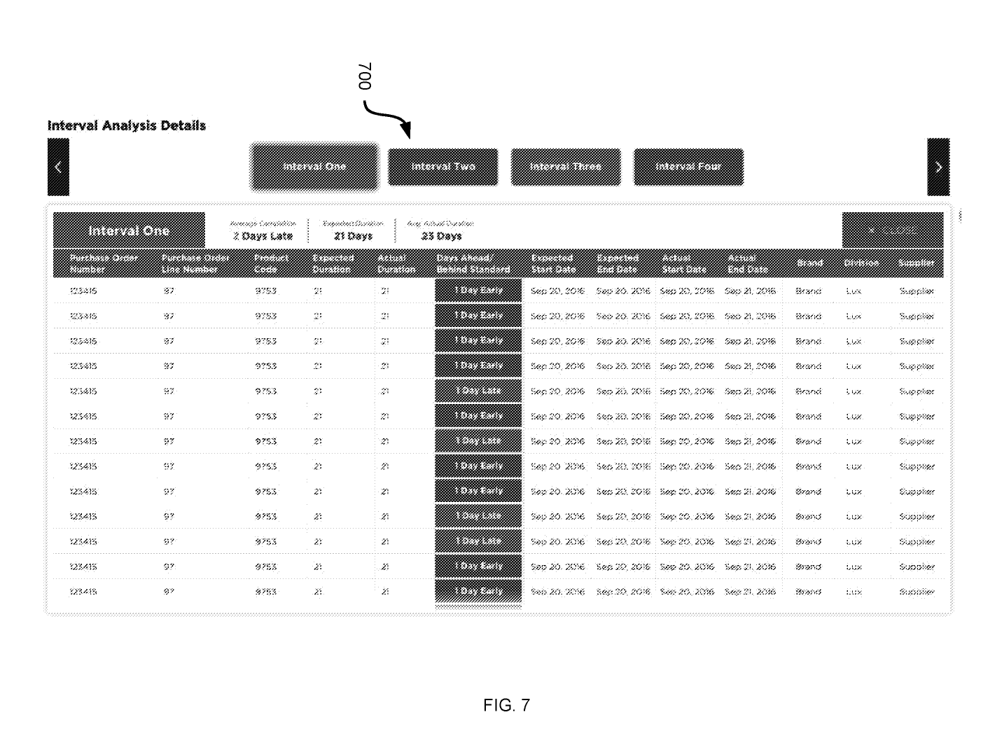

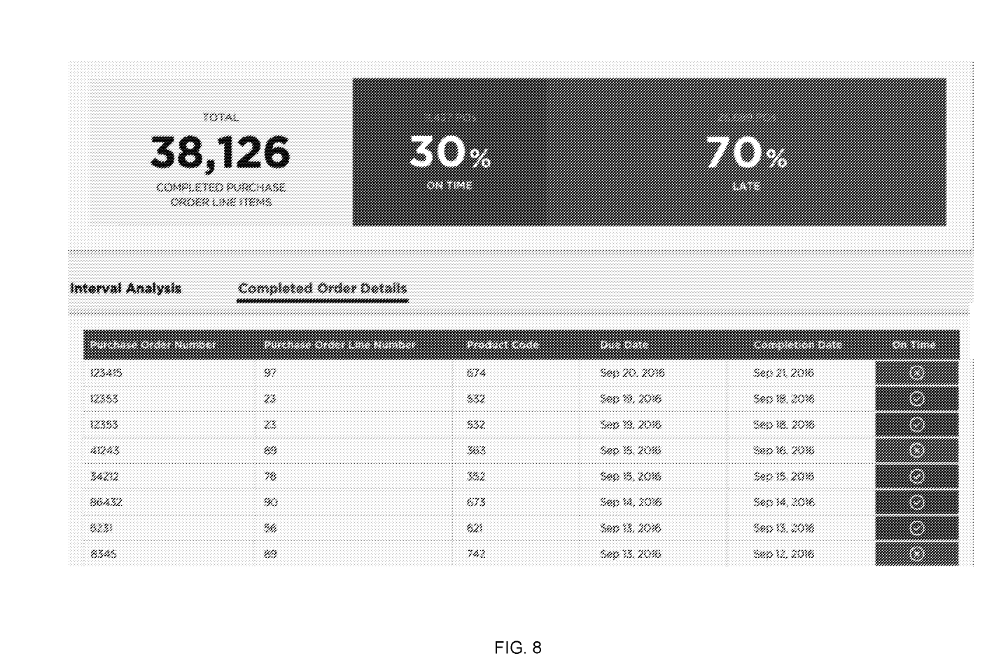

FIGS. 7 and 8 depict production reporting data summaries provided by server 120 to computing device 112, for orders falling within any selected one of four selectable time intervals 700. Intervals 700 correspond to preconfigured intervals of time (e.g. four sequential one-month periods). Responsive to receiving a selection of an interval 700, server 120 is configured to retrieve any reporting data records corresponding to orders with production deadlines within the selected interval. Server 120 is then configured to present computing device 112 with, for example, a summary of stage progress information from the retrieved reporting data.

For example, the summary in FIG. 7 depicts the expected start and end dates (as determined earlier via the use of template and deadline data) for each order. The summary also indicates, for orders that have begun production (i.e. for which at least some event reporting data has been received), the actual start date, which may be the first day on which event reporting data for the order was received. FIG. 8 presents a summary of previously completed orders, which may include the originally specified deadline as well as the actual completion date as indicated by event reporting data (e.g. indicating that the final stage defined by the template is complete).

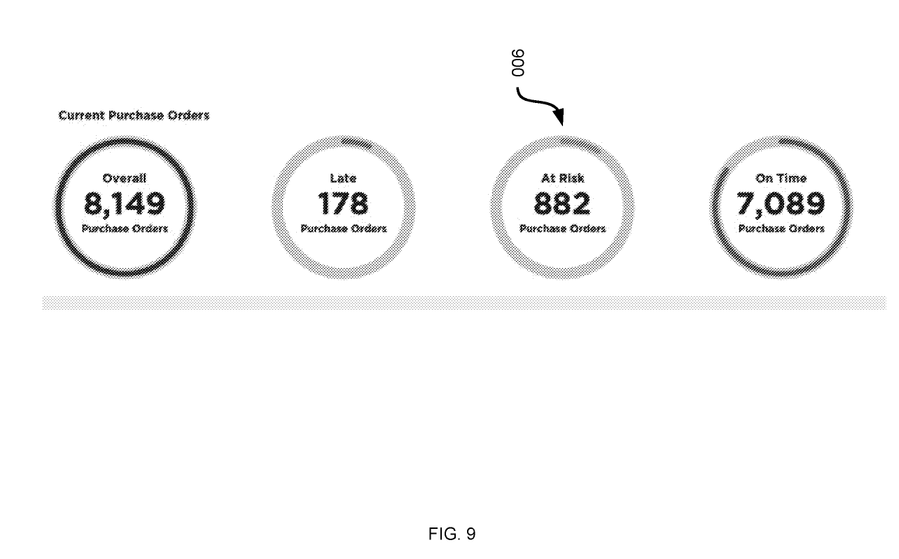

As will now be apparent, numerous instances of method 300 can be performed substantially simultaneously at server 120, for different orders, customers and suppliers. Server 120 can therefore also be configured to present, to any given customer, a dashboard interface such as that shown in FIG. 9 depicting a total number of orders, as well as a total number of orders that are not complete and beyond their original deadline and a total number of orders that are not complete but have not yet passed their original deadline.

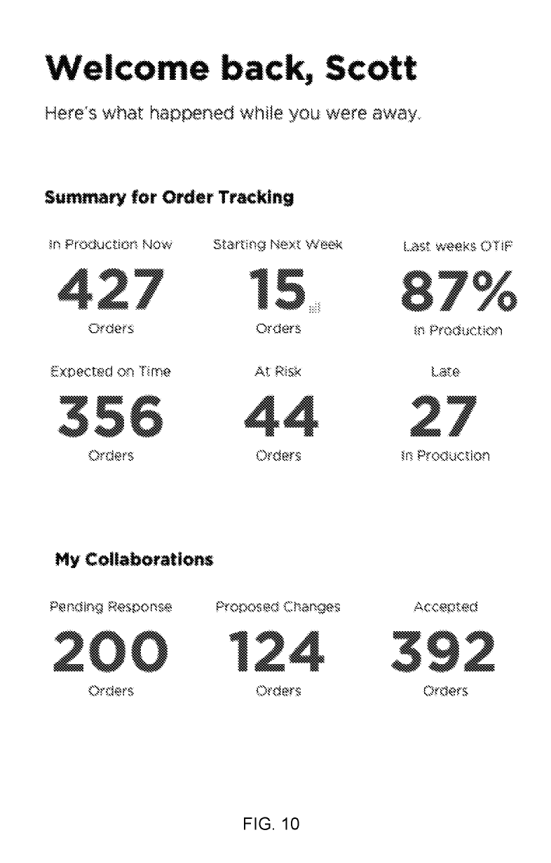

As seen at element 900, server 120 can also generate a prediction of orders that are at risk of being delivered late, based on the current contents of the reporting data records for those orders. For example, server 120 can be configured to determine a relationship between delays at initial stages of production and delays in final delivery, and to identify orders that (based on the completion dates of their initial stages) are likely to be completed late based on that relationship. FIG. 10 depicts another example dashboard interface that server 120 can be configured to present, indicating similar data to that in FIG. 9. FIG. 10, in addition to order summaries, includes a “collaborations” section summarizing production records that have not yet been finalized (i.e. for which there has not yet been an affirmative determination at block 315).

Various modifications and extensions to the above functionality are contemplated. For example, blocks 305 to 315 can be performed not only for production records (i.e. orders), but for production forecasts. Forecasts indicate planned orders, but are not finalized into actual orders. That is, negotiations may proceed as described above, but following acceptance of a forecast, the remaining blocks of method 300 are not performed, as forecasts are used solely for capacity planning purposes. Server 120 can, however, be configured to receive instructions to convert an accepted forecast record into a production record, effectively pre-populating some or all of the data in the request received at block 305.

In some embodiments, production records can be marked as accepted automatically under certain conditions, without awaiting explicit approval from computing devices 116 or 112. For example, a supplier can indicate to server 120 the conditions under which orders are to be auto-accepted (e.g. a deadline more than a specified amount of time in the future, a volume below a specified threshold). Server 120 can store such indications in the supplier profile, and compare inbound production requests to the criteria. If a request at block 305 satisfies the criteria, blocks 310 and 315 can be bypassed.

In further embodiments, server 120 can be configured, following the acceptance of an order at block 315, to automatically generate production data for transmission to a computing device 116, having a format compatible with the production management application executed by that computing device. For example, server 120 can store a set of translation rules in memory defining the data elements and their format required by the application executed by each computing device 116. Server 120 can then, upon acceptance of an order, automatically generate production data based on those rules for transmission to the relevant computing device 116. Other variations will also occur to those skilled in the art.

The scope of the claims should not be limited by the embodiments set forth in the above examples, but should be given the broadest interpretation consistent with the description as a whole.

1. A method, in an intermediate server, of synchronizing reporting data between a requestor computing device and an effector computing device, comprising:
storing a plurality of event identifiers at the intermediate server;
storing a plurality of reporting templates at the intermediate server, each reporting template having: (i) a template identifier, and (ii) a mapping between a subset of the plurality of event identifiers and a set of reporting stages;
responsive to receiving a production task request from the requestor computing device, obtaining a selected templated identifier of a selected one of the templates;
generating a reporting data record corresponding to the production task request, the reporting data record including respective fields for the stages defined by the selected reporting template;
responsive to relaying the production task request to the effector computing device, receiving reporting data from the effector computing device, the reporting data containing values corresponding to each of a reported subset of the events;
storing a portion of the values in the reporting data record according to the mapping defined by the selected reporting template; and
transmitting the reporting data record to the requestor computing device.

2. The method of claim 1, wherein the number of stages in the mapping is smaller than the number of event identifiers in the mapping.

3. The method of claim 1, wherein obtaining the selected template identifier includes automatically selecting the selected template identifier based on the production task request.

4. The method of claim 1, wherein obtaining the selected template identifier includes receiving a template selection from the effector computing device.

5. The method of claim 1, further comprising:
prior to generating the reporting data record, receiving the production task request from the requestor computing device, the production task request containing an item identifier, a quantity corresponding to the item identifier, and a production deadline corresponding to the item identifier.

6. The method of claim 5, wherein the selected template further includes, for each of the set of stages, a target completion date generation rule; and
wherein generating the reporting data record includes generating a target completion date for each of the set of stages, based on the completion date generation rules.

7. The method of claim 6, wherein each completion date generation rule defines a target completion date relative to the production deadline.

8. The method of claim 1, further comprising:
responsive to receiving reporting data containing a value for an event that is not identified in the mapping of the selected template, discarding the value.

9. The method of claim 1, wherein transmitting the reporting data record includes receiving a request for the reporting data record from the requestor computing device, and transmitting the reporting data record responsive to the request.

10. A server for synchronizing reporting data between a requestor computing device and an effector computing device, comprising:
a memory storing:
a plurality of event identifiers; and
a plurality of reporting templates, each reporting template having: (i) a template identifier, and (ii) a mapping between a subset of the plurality of event identifiers and a set of reporting stages;
a communications interface; and
a processor interconnected with the memory and the a communications interface, the processor configured to:
responsive to receiving a production task request from the requestor computing device, obtain a selected templated identifier of a selected one of the templates;
generate a reporting data record corresponding to the production task request, the reporting data record including respective fields for the stages defined by the selected reporting template;
responsive to relaying the production task request to the effector computing device, receive reporting data from the effector computing device, the reporting data containing values corresponding to each of a reported subset of the events;
store, in the memory, a portion of the values in the reporting data record according to the mapping defined by the selected reporting template; and
transmit the reporting data record to the requestor computing device.

11. The server of claim 10, wherein the number of stages in the mapping is smaller than the number of event identifiers in the mapping.

12. The server of claim 10, the processor further configured to obtain the selected template identifier by automatically selecting the selected template identifier based on the production task request.

13. The server of claim 10, the processor further configured to obtain the selected template identifier by receiving a template selection from the effector computing device.

14. The server of claim 10, the processor further configured to:
prior to generating the reporting data record, receive the production task request from the requestor computing device, the production task request containing an item identifier, a quantity corresponding to the item identifier, and a production deadline corresponding to the item identifier.

15. The server of claim 14, wherein the selected template further includes, for each of the set of stages, a target completion date generation rule;
the processor further configured to generate the reporting data record by generating a target completion date for each of the set of stages, based on the completion date generation rules.

16. The server of claim 15, wherein each completion date generation rule defines a target completion date relative to the production deadline.

17. The server of claim 10, the processor further configured to:
responsive to receiving reporting data containing a value for an event that is not identified in the mapping of the selected template, discard the value.

18. The server of claim 10, the processor further configured to transmit the reporting data record by receiving a request for the reporting data record from the requestor computing device, and transmitting the reporting data record responsive to the request.
